(19) United States
(12) Patent Application Publication
(10) Pub. No.: US 2024/0051131 A1
(43) Pub. Date: Feb. 15, 2024

(54) GAP DETECTION DEVICE AND GAP DETECTION METHOD FOR ROBOT JOINT

(71) Applicants: FANUC CORPORATION, Yamanashi (JP); TOKYO INSTITUTE OF TECHNOLOGY, Tokyo (JP)

(72) Inventors: Hiroshi NAKAGAWA, Yamanashi (JP); Kenichiro ABE, Yamanashi (JP); Hideo MATSUI, Yamanashi (JP); Tomoaki NAGAYAMA, Yamanashi (JP); Yukio TAKEDA, Tokyo (JP); Masumi OHNO, Yamanashi (JP)

(21) Appl. No.: 18/257,294

(22) PCT Filed: Jan. 12, 2022
(86) PCT No.: PCT/JP2022/000787

§ 371 Date: Jun. 14, 2023

(30) Foreign Application Priority Data
Jan. 18, 2021 (JP) 2021-005871

(51) Int. Cl. B25J 9/16; B25J 19/06

(52) U.S. Cl. CPC B25J 9/1641; B25J 19/06; B25J 9/163; B25J 9/1674

(57) ABSTRACT

A gap detection device includes: a measurement unit measuring the driving torque or current value of a motor when the robot is actually being operated along an arbitrary motion trajectory; a simulation unit setting an arbitrary second gap amount between pairing elements of a plurality of pairing elements, performing a simulation in which the robot operates along the same arbitrary motion trajectory, and estimating the driving torque or the current value of the motor; a feature amount calculation unit calculating a first feature amount indicating fluctuations of a value related to the measured driving torque or current value, and a second feature amount indicating fluctuations of a value related to the estimated driving torque or current value; and a gap calculation unit calculating an index related to a first gap amount on the basis of the first feature amount, the second feature amount, and the second gap amount.

### TECHNICAL FIELD

The present invention relates to a device and a method for detecting a gap at a joint of a robot.

### BACKGROUND ART

As an example of a robot having a link mechanism, a parallel link robot having a delta-type parallel link mechanism for positioning a movable part having an end effector in three-dimensions is well known. The delta-type parallel link robot has a base part, a movable part, and a drive link and a passive link for connecting the movable part to the base part. In many cases, three pairs of drive link and passive link are provided, and the movable part can move with three degrees-of-freedom (X, Y, Z) by individually controlling the motion of each pair.

Generally, the passive link and the drive link, and the passive link and the movable part are connected by ball joints having three degrees-of-freedom, and the ball joint can be classified into a separate type and an integrated type. As the prior art for detecting disconnection at the separate type ball joint, a parallel link robot having a sensor is well known, wherein the sensor detects inclination of an end plate which is a final output of the parallel link robot, and disconnection between links is detected at at least one of a plurality of connection points of the links, based on an output value of the sensor (e.g., see Patent Literature 1).

Further, a detection device is well known wherein an internal passage is formed so as to open on a surface of a spherical head of a ball joint, and whether or not disconnection of the ball joint occurs is determined based on a detection value of the pressure in the internal passage (e.g., see Patent Literature 2).

On the other hand, the integrated type ball joint has a link ball structure in which a ball and a housing are integrated so that the housing and the ball are not easily separated from each other, for example. As the prior art for detecting the gap between the housing and the ball in the integrated type ball joint, a device and a method are well known, wherein a motion trajectory of the robot where the ball and housing collide with each other in a target joint and the ball and housing slide in the other joints is generated, and the presence of an abnormal gap in the target joint is determined based on the magnitude of torque fluctuation when the robot is driven along the generated motion trajectory (e.g., see Patent Literature 3 and 4).

### CITATION LIST

### Patent Literature

[PTL 1] JP 2017-056507 A
[PTL 2] JP 2017-013160 A
[PTL 3] JP 2019-136838 A
[PTL 4] JP 2020-142353 A

### SUMMARY OF INVENTION

### Technical Problem

In the separate type ball joint, there is a risk that, when an unexpected high-speed motion or collision occurs, a restraining force to attract the ball to the housing may be reduced, with the result that the joint of the passive link may be disassembled.

On the other hand, in the integrated type ball joint, it is understood that the ball and the housing are not easily separated due to the mechanical connection, even when a collision, etc., occurs. However, in the case where the link ball structure is used, when the ball or the housing wears out due to use, a gap may be generated between the ball and the housing, which can lead to deterioration in the positioning accuracy of the movable part of the robot and/or an increase in vibration. Due to the deterioration of positioning accuracy and/or increase in vibration, it may be difficult for the robot to normally perform a handling operation and/or assembly operation, which may lead to serious problems such as reduction in production efficiency and stoppage of the production process. Therefore, when there is an abnormality in the gap between the link ball part, it is desirable to know of the abnormal state at an early stage.

In a conventional method for detecting disengagement in a ball joint, it is difficult to detect that a gap between the ball and the housing (socket) has increased in the ball joint which is not easily disengaged. This is because a gap of about 0.1 to 0.2 mm is generally considered abnormal, and it is extremely difficult to detect such a minute gap by a sensor, etc.

In addition, the robot motion performed to identify a joint having an abnormal gap may be special, different from normal production operations, etc., and it may be difficult to perform such a special robot motion due to interference between the robot and peripheral equipment and/or layout constraints including the robot. Therefore, a method capable of detecting an abnormal gap even in normal production operations is desired.

### Solution to Problem

One aspect of the present disclosure is an armature of a gap detection device for a robot, the robot comprising: a drive link configured to be driven by a motor; a plurality of passive links configured to be driven by a motion of the drive link; and a plurality of pairs respectively connected to the plurality of passive links, wherein the gap detection device is configured to detect a first gap amount between pairing elements of a pair connected to the passive link, and the gap detection device comprises: a measurement unit configured to measure a drive torque or a current value of the motor when the robot is actually moved along an arbitrary motion trajectory; a simulation unit configured to set an arbitrary second gap amount between pairing elements of the plurality of pairs, execute a simulation in which the robot is moved along the same motion trajectory as the arbitrary motion trajectory, and estimate the drive torque or the current value of the motor; a feature amount calculation unit configured to calculate a first feature amount representing a variation in a value relating to the drive torque or the current value measured by the measurement unit and a second feature amount representing a variation in a value relating to the drive torque or the current value estimated by the simulation unit; and a gap calculation unit configured to calculate an index relating to the first gap amount based on the first feature amount, the second feature amount and the second gap amount.

Another aspect of the present disclosure is a gap detection method for a robot, the robot comprising: a drive link configured to be driven by a motor; a plurality of passive links configured to be driven by a motion of the drive link; and a plurality of pairs respectively connected to the plurality of passive links, wherein the gap detection method is to detect a first gap amount between pairing elements of a pair connected to the passive link, and the gap detection method comprises the steps of: measuring a drive torque or a current value of the motor when the robot is actually moved along an arbitrary motion trajectory; setting an arbitrary second gap amount between pairing elements of the plurality of pairs, executing a simulation in which the robot is moved along the same motion trajectory as the arbitrary motion trajectory, and estimating the drive torque or the current value of the motor; calculating a first feature amount representing a variation in a value relating to the measured drive torque or the measured current value and a second feature amount representing a variation in a value relating to the estimated drive torque or the estimated current value; and calculating an index relating to the first gap amount based on the first feature amount, the second feature amount and the second gap amount.

A further aspect of the present disclosure is a gap detection device for a robot, the robot comprising: a first link configured to be driven by a motor; a second link configured to the first link; and one or more pairs connected to the second link, wherein the gap detection device is configured to detect a first gap amount between pairing elements of a pair connected to the second link, and the gap detection device comprises: a measurement unit configured to measure a first output value of the motor when the robot is actually moved along an arbitrary motion trajectory; a simulation unit configured to set an arbitrary second gap amount between pairing elements of the pair, execute a simulation in which the robot is moved along the motion trajectory, and estimate a second output value of the motor; and a gap calculation unit configured to calculate the first gap amount based on a change in the first output value, a change in the second output value and the second gap amount.

### Advantageous Effects of Invention

According to the present disclosure, it is possible to easily and accurately identify a gap in each pair (joint) of a robot and determine whether the gap is abnormal. In addition, such identification and determination can be performed in an arbitrary motion of the robot, and are not subject to restrictions such as the layout of the robot.

### BRIEF DESCRIPTION OF DRAWINGS

FIG. 1 is a view showing a gap detection device according to a preferred embodiment, with a delta-type parallel link robot to which the device can be applied.

FIG. 2 is a partial enlarged view showing a structure of each ball joint of the parallel link robot of FIG. 1.

FIG. 3 is a view showing a structure model of the parallel link robot.

FIG. 4 is a flowchart showing an example of a cap detection method according to a first example.

FIG. 5 is a graph showing an example of a temporal change in drive torque of a motor.

FIG. 6 is a graph showing an example of a temporal change in a difference between measured drive torque and a normal condition.

FIG. 7 is a flowchart showing an example of a cap detection method according to a second example.

FIG. 8 is a flowchart showing an example of a dynamics analysis procedure.

FIG. 9 is a view showing an example of a mass model of the parallel link robot mechanism.

FIG. 10 is a view for explaining constraint conditions of a pair in consideration of the gap.

FIG. 11 is a view showing an example of a torque calculation method.

FIG. 12 is a view showing, in tabular form, combinations of gaps of pairs wherein dynamic analysis and actual machine measurement are used.

FIG. 13 is a view showing the coordinates of start and end points of a large number of generated trajectories in tabular form.

FIG. 14 is a graph showing an example of an acceleration waveform in the motion direction of an output node of the robot.

FIG. 15a is a data scatter diagram obtained by applying principal component analysis to results of dynamic analysis for a certain pair.

FIG. 15b is a data scatter diagram obtained by applying principal component analysis to results of dynamic analysis for a certain pair.

FIG. 15c is a data scatter diagram obtained by applying principal component analysis to results of dynamic analysis for a certain pair.

FIG. 15d is a data scatter diagram obtained by applying principal component analysis to results of dynamic analysis for a certain pair.

FIG. 15e is a data scatter diagram obtained by applying principal component analysis to results of dynamic analysis for a certain pair

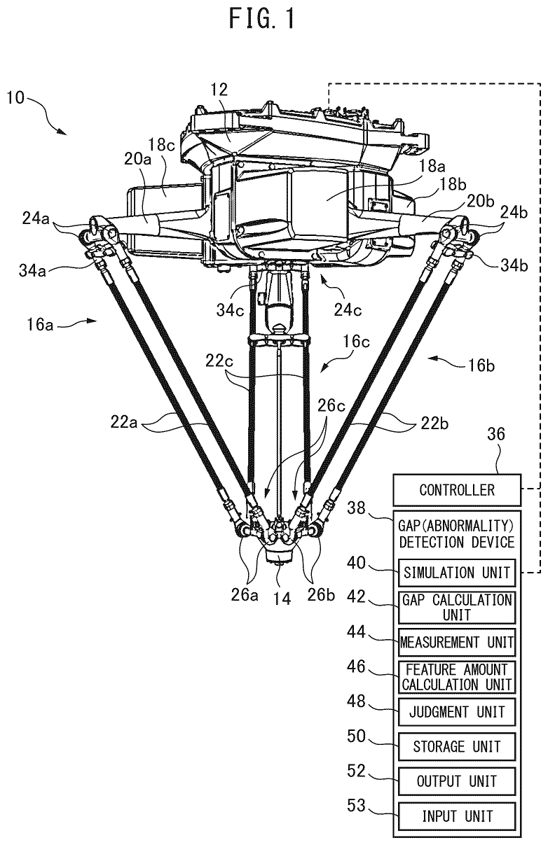

FIG. 1f is a data scatter diagram obtained by applying principal component analysis to results of dynamic analysis for a certain pair.

FIG. 16a is a data scatter diagram obtained by applying principal component analysis to results of actual machine measurement for a certain pair.

FIG. 16b is a data scatter diagram obtained by applying principal component analysis to results of actual machine measurement for a certain pair.

FIG. 16c is a data scatter diagram obtained by applying principal component analysis to results of actual machine measurement for a certain pair.

FIG. 16d is a data scatter diagram obtained by applying principal component analysis to results of actual machine measurement for a certain pair.

FIG. 16e is a data scatter diagram obtained by applying principal component analysis to results of actual machine measurement for a certain pair.

FIG. 16f is a data scatter diagram obtained by applying principal component analysis to results of actual machine measurement for a certain pair.

FIG. 17 is a flowchart showing an example of a verification procedure.

FIG. 18 is FIG. 1 is a graph showing results of verification performed according to the procedure of FIG. 17.

FIG. 19 is a view schematically showing another structural example to which the present embodiment can be applied.

FIG. 20 is a view schematically showing still another structural example to which the present embodiment can be applied.

### DESCRIPTION OF EMBODIMENTS

FIG. 1 is a view showing schematic configurations of a cap detection device according to a preferred embodiment of the present disclosure, and a delta-type parallel link robot, as a structural example to which the gap detection device can be applied. The parallel link robot 10 (hereinafter, also be referred to as “robot”) has a base part 12; a movable part 14 positioned away from (normally, positioned below) the base part 12; two or more (in the illustrated embodiment, three) link parts 16a, 16b and 16c which connect the movable part 14 to base part 12, each link part including one degree-of-freedom relative to the base part 12; and a plurality of (normally the same number as the link parts, and in the illustrated embodiment, three) motors 18a, 18b and 18c, such as servomotors, which respectively drive the link parts 16a, 16b and 16c. To the movable part 14, an end effector such as a robot hand can be attached.

The link part 16a is constituted by a drive link 20a connected to the base part 12 and a pair of (two) passive links (distal joint links) 22a which extend parallel to each other and connect the drive link 20a to the movable part 14. The drive link (first link) 20a and the passive links (second links) 22a are connected to each other by a pair of (two) first joints 24a. Further, the movable part 14 and the passive links 22a are connected to each other by a pair of (two) second joints 26a. In this embodiment, both the first and second joints (pairs) are formed as ball joints (or spherical joints).

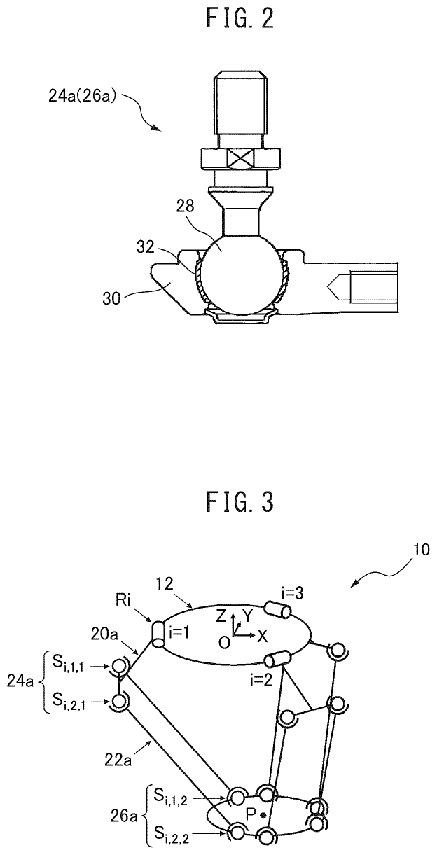

FIG. 2 is a partially enlarged view of a structure (or a link ball structure) of each ball joint (in this case, the ball joints 24a or 26a) of the robot 10. As pairing elements (joint elements) as described below, the ball joint 24a or 26a has a ball 28 (or a convex surface), a housing 30 (or a concave surface) for containing the ball 28, and a liner 32 positioned between the ball 28 and the housing 30. Further, as shown in FIG. 1, at the drive link side (or the upper part) of the passive links, the robot 10 has a restraining plate 34a positioned and connected between the housings of the first ball joints 24a so as to restrict rotation of the two parallel passive links 22a about each axis of the robot.

The other link parts 16b and 16c may have the same configuration as the link part 16a. Therefore, the components of the link parts 16b and 16c corresponding to the components of the link part 16a are provided with respective reference numerals in which only the last character is different from the reference numeral of the link part 16a (e.g., the components of the link parts 16b and 16c corresponding to the passive link 22a are provided with reference numerals 22b and 22c, respectively), and a detailed explanation thereof will thus be omitted.

As schematically shown in FIG. 1, a controller 36 configured to control the parallel link robot 10 is connected to the robot 10. Further, a gap detection device 38, for detecting an actual gap or clearance (a first gap amount) in the ball joint, has: a measurement unit 44 such as a torque sensor or an ammeter configured to measure a drive torque or a current value of the motors 18a to 18c when the robot 10 is actually moved along an arbitrary motion trajectory; a simulation unit 40 configured to set an arbitrary second gap amount between pairing elements of a plurality of pairs, execute a simulation in which the robot 10 is moved along the same motion trajectory as the arbitrary motion trajectory, and estimate the drive torque or the current value of the motors 18a to 18c; a feature amount calculation unit 46 configured to calculate a first feature amount or characteristic quantity representing a variation in a value relating to the drive torque or the current value measured by the measurement unit 44 and a second feature amount or characteristic quantity representing a variation in a value relating to the drive torque or the current value estimated by the simulation unit 40; and a gap calculation unit 42 configured to generate a mathematical model (described below) which associates the first feature amount, the second feature amount, the first gap amount and the second gap amount, and calculate an index relating to the first gap amount based on the mathematical model. Optionally, the dap detection device 38 may have a judgment unit 48 configured to judge as abnormal the gap of the pair whose index relating to the first gap amount exceeds a predetermined reference value, among the plurality of pairs. In this case, the gap detection device 38 may function as an abnormal detection device for detecting as to whether or not each pair has an abnormal (excessive) gap.

The robot controller 36 is configured to generate a motion command for operating the robot 10, and control each axis (or the motor thereof) of the robot 10 based on the motion command. In addition, the gap detection device 38 may have: a storage unit 50 such as a memory configured to store the measurement data and the feature amount, etc.; an output unit 52 configured to output results of the above simulation and the judgment so that the operator can recognize the results; and an input unit 53 such as a keyboard or touch panel by which the operator can input various setting or data. A specific example of the output unit 52 may include: a display for displaying the results of the simulation and the judgment, a speaker for outputting the results of the simulation and the judgment as sound; and a vibrator which can be carried by the operator and vibrates when an abrasion state of the joint is abnormal (or when there is an abnormal gap in the joint). The operator can receive the output from the output unit 52 and repair or replace the joint having the abnormality.

The gap detection device 38 can be realized as an arithmetic processing unit such as a personal computer (PC) having a processor and a memory, etc., connected to the robot controller 36. Although the gap detection device 38 is shown as a device separated from the robot controller 36 in FIG. 1, the device 38 may be incorporated in the controller 36 as a processor and a memory, etc. Further, a part of the gap detecting function may be allocated to a device such as a PC, and the other function allocated to the robot controller 36.

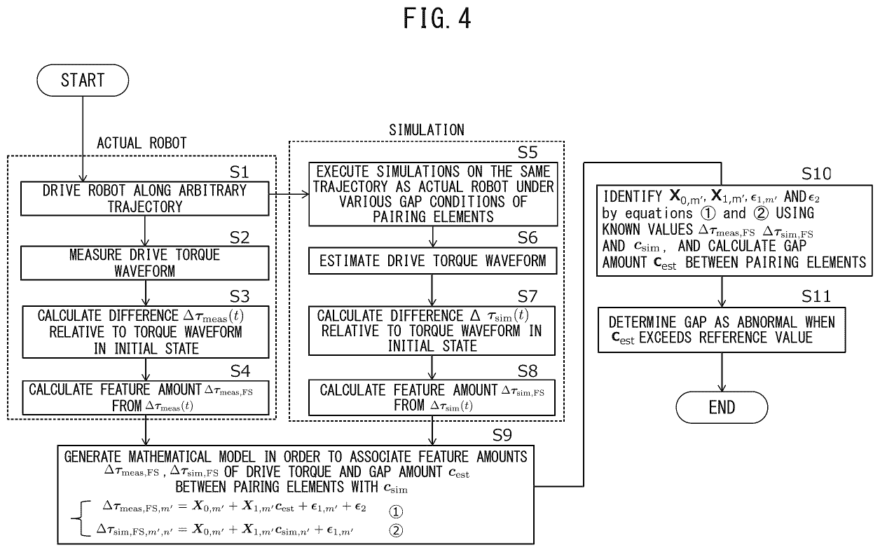

FIG. 3 shows a structural model of the parallel link robot 10 of FIG. 1. The parallel link robot 10 has a closed-loop link mechanism including three rotational drive units (or motors) and twelve passive pairs (in this example, ball joints).

With reference to FIG. 2, in each joint, the ball 28 slides on the liner 32 due to the motion of the robot 10. In many cases, in order to reduce a frictional resistance between the ball 28 and the liner 32, the liner 32 is made from a low-friction material such as a resin, etc. In this regard, since the liner 32 is abraded by repetition of the robot motion, a clearance (or an air gap) is generated between the ball 28 and the liner 32 (or the housing 30). When the magnitude of the gap is increased to a certain value, the positional accuracy of the robot 10 may be deteriorated, and/or the amplitude of vibration due to the robot motion may be increased. Therefore, in the embodiment, a dynamics analysis is performed to identify the gap in each joint for an arbitrary robot motion, and it is judged as to whether or not the gap has an abnormal value.

### First Example

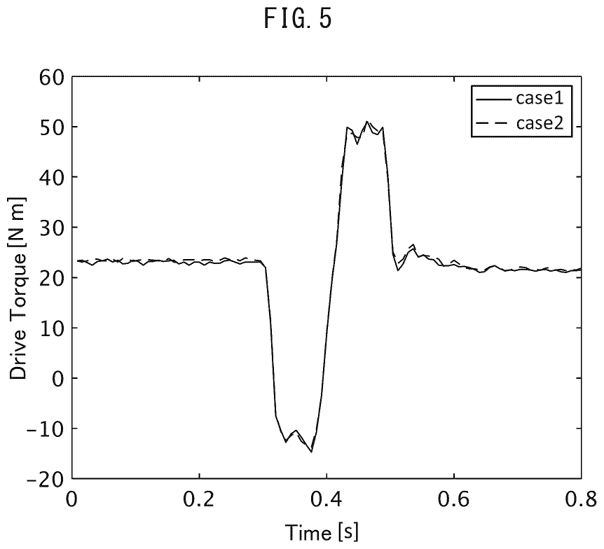

FIG. 4 is a flowchart showing an example of a process in the gap detection device 38 according to a first example. First, in step S1, the actual robot 10 whose (abnormal) gap is to be detected is driven along an arbitrary motion trajectory. Specifically, one or more robot motion trajectories are provided which are used to identify the gap in the pair or the pair gap. Here, the trajectory is determined by the character m′. The arbitrary motion trajectory is, for example, used for a production motion in a factory.

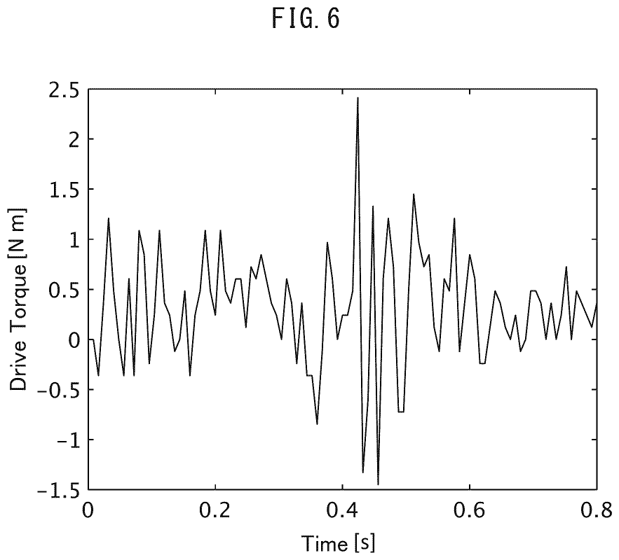

Next, in step S2, the drive torque waveform of the motor which drives each axis of the robot 10 (specifically, the drive torque τ_{meas,m′} (t) of the motor during operation) is measured. In this regard, since the parallel link robot usually has three actuators, the torque waveform corresponds to a vector combining the waveforms of the three actuators. An example of the torque waveform at this time is shown in FIG. 5. For example, the measured data is stored in the storage unit 50 once to several times a day.

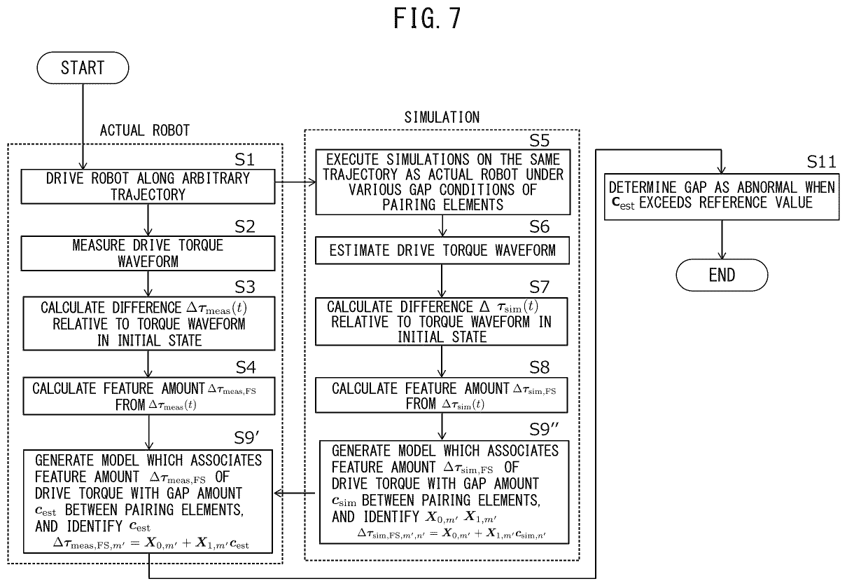

Next, in step S3, the difference between the measured torque waveform and the torque waveform in the initial state is calculated. Specifically, the ideal waveform τ_{meas,ideal,m′} (t) of the driving torque is previously calculated using the same motion trajectory as the measurement and under the condition that the gaps in all pairs are normal, and then the waveform Δτ_{meas,m′} (t) corresponding to the difference between the ideal waveform τ_{meas,ideal,m′} (t) and the torque waveform τ_{meas,m′} (t) measured in step S2 is calculated using the following equation (1). An example of the torque waveform at this time is shown in FIG. 6.

[Math 1]

Δτ_{meas,m′}(t)=τ_{meas,m′}(t)−τ_{meas,ideal,m′}(t) (1)

On the other hand, using the same trajectory as the trajectory used in the actual machine measurement, a simulation (dynamic analysis), which will be described later, is performed (S5), and the drive torque waveform τ_{sim,m′,n′} (t) is estimated (S6). A simulation result is stored in the storage unit 50, etc. In order to identify the pair gap by comparing the result of the dynamic analysis and the result of the actual machine measurement in the later process, the dynamic analysis is performed under various conditions c_{sim,n′} of the pair gap. The condition of the pair gap is determined by a character n′. As for the result of the dynamic analysis, similarly to step S3, the waveform Δτ_{sim,m′,n′} (t) corresponding to the difference relative to the ideal waveform is calculated using the following equation (2) (S7).

[Math 2]

Δτ_{sim,m′,n′}(t)=τ_{sim,m′,n′}(t)−τ_{sim,ideal,m′}(t) (2)

In this regard, since Δτ_{meas,m′} (t) and Δτ_{sim,m′,n′} (t) in equations (1) and (2) are time series data and multi-dimensional data, the calculations using these values tend to be complex and time consuming. Therefore, in order to reduce the amount of calculation for gap estimation described below, the dimensions of time-series data are reduced by feature selection.

Specifically, when comparing the drive torque data obtained on the same trajectory and under different conditions of the pair gap, the difference (variation) in the waveforms thereof is considered to be due to changes in the conditions of the pair gap. Therefore, by setting new orthogonal coordinates in descending order of the degree of variation and extracting a first few coordinates as new variables, it is possible to reduce the number of dimensions of the data while extracting the effect of the pair gap. Here, feature selection based on principal component analysis is executed. The data dimensions are reduced by the feature selection, and feature amounts Δτ_{meas,FS} (a first feature amount) and Δτ_{sim,FS} (a second feature amount) of a new drive torque are calculated (S4, S8).

In addition, although a method of feature selection using only the principal component analysis is described in this embodiment, it is expected to improve the accuracy of the mathematical model by combining, for example, signal processing methods such as Fourier transform and wavelet transform and various feature selection methods belonging to the field of machine learning. For example, by extracting only a specific frequency region which is likely to be affected by the pair gap by using Fourier transform or wavelet transform, it is possible to eliminate other error factors and improve the accuracy of the model. Also, the data dimensions are reduced by extracting the specific frequency region. The data dimensions are further reduced by applying the above principal component analysis to the extracted specific frequency data region.

Next, in step S9, a mathematical model which associates the characteristic quantity of the drive torque obtained by the dynamic analysis and the actual machine measurement with the size of the pair gap is constructed, as shown in the following equation (3).

[Math 3]

Δτ_{meas,FS,m′}=X_{0,m′}+X_{1,m′}cₑₛₜ+ϵ_{1,m′}+ϵ₂

Δτ_{sim,FS,m′,n′}=X_{0,m′}+X_{1,m′}c_{sim,n′}+ϵ_{1,m′} (3)

Here, cₛᵢₘ represents the size of the pair gap (second gap amount) for which the dynamic analysis is performed, and cₑₛₜ represents the actual size of the pair gap (first gap amount) to be identified as an unknown quantity. The mathematical model is represented by a probabilistic model. In equation (3), the first formula in equation (3) is a model relating to the actual machine measurement, and the second formula is a model relating to the simulation (the dynamic analysis). The error terms ϵ_{1,m′} and ϵ₂ are random variables following a certain probability density function. Herein, based on the knowledge that torque fluctuation increases as the pair gap increases, we have adopted the simplest model that satisfies this condition, i.e., a model in which these variables are associated by a linear expression regarding the gap.

The term ϵ_{1,m′} is considered as an error due to modeling in the linear expression. Since the dynamics of the parallel link robot with pair gap is nonlinear dynamics, a nonlinear term exists. It is considered that the influence of the nonlinear term becomes larger, as the number of pairs for which gaps to be taken into account at the same time increases. In order to consider this influence, the error term ϵ_{1,m′} is set. The error term ϵ₂ accounts for the difference between the mathematical model of the dynamics analysis and the actual machine measurement. The main reason for this difference is the modeling error in the dynamic analysis and/or the measurement error in the actual machine measurement. In this embodiment, the error terms ϵ_{1,m′} and ϵ₂ are modeled by the following equation (4), assuming that these terms follow a (multivariate) normal distribution.

[Math 4]

ϵ_{1,m′}˜N(0,Σ_{m′})

ϵ₂˜N(0,o²I) (4)

The character N (μ, Σ) represents a multivariate normal distribution with mean μ and variance-covariance matrix Σ. The character I is an identity matrix. The term ϵ_{1,m′} is modeled as following the multivariate normal distribution, considering the correlation between feature amounts in the same trajectory. Regarding the non-linear term described above, it is assumed that the value of the feature amount which appears due to the gap in a certain sphere pair will change under the influence of the gap in another sphere pair. The reason why the correlation between the feature amounts in the same trajectory is taken into consideration is that this change appears as a correlation of the error. On the other hand, the term ϵ₂ is modeled as all elements following the same one-dimensional normal distribution.

Next, in step S10, the pair gap is identified by solving the constructed mathematical model, more specifically, calculating the maximum likelihood estimation solution of the constructed mathematical model (S10). Since the mathematical model constructed in this embodiment includes two kinds of error terms, it is difficult to calculate an exact solution as in the least squares matrix calculation. Therefore, as an example, it is considered that an approximate value of the maximum likelihood estimation solution is derived by Bayesian estimation using an MCMC method, which is a kind of Monte Carlo method. In Bayesian estimation, parameters of a probability model are estimated as random variables based on the concept of Bayesian statistics. By calculating a mode value of the probability distribution regarding the pair gap derived by the MCMC method, the maximum likelihood estimation solution regarding the pair gap can be calculated. In addition, since the gap amount can be calculated from the probability distribution, the likelihood of the estimated gap amount can be understood. In this embodiment, the maximum likelihood estimation solution obtained in this way is defined as an estimated value of the pair gap (the index relating to the first gap amount).

Finally, in step S11, an abnormal gap is detected from the estimated size of the gap. Specifically, the estimated value of the gap is compared with a predetermined reference value considered to be abnormal, and when the estimated value is equal to or greater than the reference value, the gap is determined to be abnormal. Thus, in this embodiment, in addition to being able to quantitatively estimate the gap amount of each pair, it is possible to automatically determine an abnormal pair (having an excessively large gap).

### Second Example

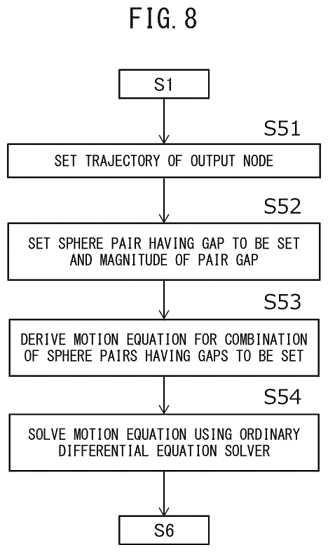

FIG. 7 is a flowchart showing an example of the process in the gap detection device 38 according to a second example. In this example, only points different from the first example will be described, and descriptions of points that may be the same as the first embodiment will be omitted.

In the first example, the first and second expressions of equation (3) are simultaneously solved by Bayesian estimation. On the other hand, in the second example, the coefficients X_{0,m′} and X_{1,m} are previously calculated from the result of the dynamic analysis. In other words, in the second example, the coefficients X_{0,m′} and X_{1,m′} are previously identified from the values of Δτ_{sim,FS,m′,n′} and c_{sim,n′} (S9″), and the pair gap cₑₛₜ of the actual robot is estimated based on the value of Δτ_{meas,FS,m′} obtained by the measurement and the identified values of X_{0,m′} and X_{1,m′} (S9′).

Both the first and second examples can be applied to the case where the motion trajectory of the robot used to estimate the gap changes, by following the processes (a) to (d) described below.
(a) The gap calculation unit 42, etc., divides a period of time before and after a time point when the motion trajectory changes.
(b) The measurement unit 44, etc., measures the torque using the same motion trajectory in each of the divided periods of time.
(c) Δτ_{meas,m′} (t) is calculated by applying the torque waveform initially measured in each period of time to τ_{meas,ideal,m′} (t) in equation (1).
(d) In all of the divided periods of time, the gap calculation unit 42, etc., uses Δτ_{meas,m′} (t) obtained in item (c), and identifies the gap in each period of time using the method of the above examples. Since the identified gap corresponds to the amount of change in the gap in each period of time, it is possible to identify the pair gap after the motion trajectory has changed, by adding these amounts of change.

### (Simulation)

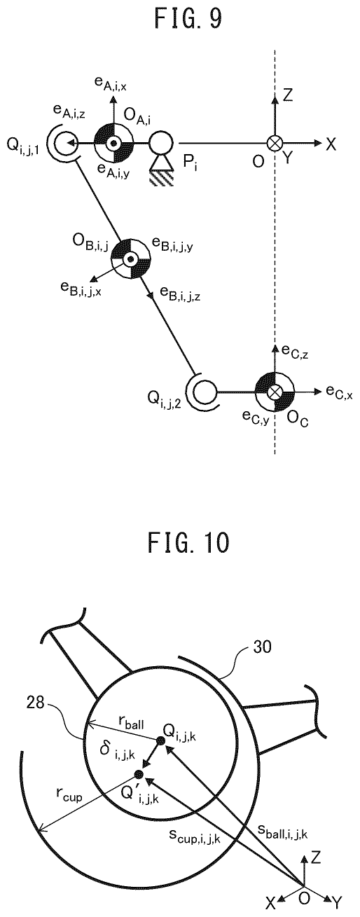

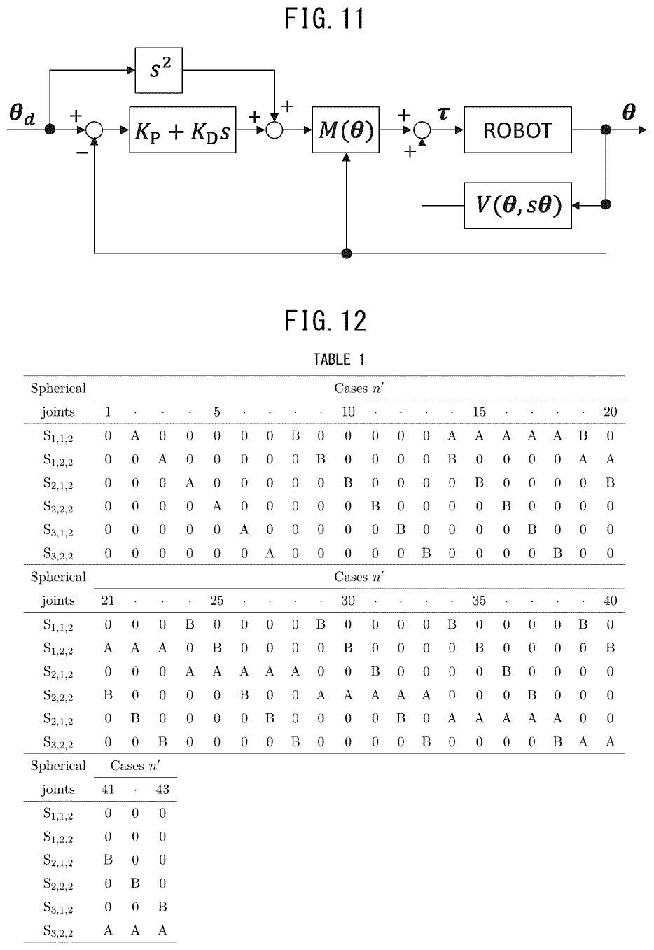

With reference to FIG. 8, the details of step S5, i.e., the procedure of simulation (dynamic analysis), when the parallel link robot 10 having the gap in a specific spherical pair is operated along a certain trajectory, will be described. Here, among twelve sphere pairs of the parallel link robot 10, the gaps in some of the sphere pairs are considered and analyzed. It is assumed that sphere pairs other than the target sphere pairs whose gaps to be considered, and rotating pairs are ideally behaved, and therefore the gaps of the sphere pairs other than the target sphere pairs and the rotating pairs are not considered. Assuming that all links are rigid, except for the viscoelasticity relating to contact between the pairing elements, and a mass model of the parallel-link robot mechanism as shown in FIG. 9 is considered.

First, as shown in FIG. 8, the target trajectory of the output node (e.g., the movable plate 14 shown in FIG. 1) to be operated by the robot is set (S51). Next, a sphere pair for which an arbitrary gap should be set and the magnitude of the gap in the sphere pair are set (S52). Next, a motion equation is derived for a combination of the sphere pairs with set gaps (S53). Finally, the motion equation is solved using an ordinary differential equation solver, etc., to obtain a numerical solution of the drive torque (S54). By virtue of this, dynamic analysis for calculating the drive torque is possible.

A specific example of the method of deriving the motion equation in step S53 will be described. First, the motion equation using the generalized coordinates q^{l} is represented by equation (5) below.

[Math 5]

M_{l,m}\ddot{q}ₘ+C_{l,m,n}\dot{q}^{m}\dot{q}ⁿ=Fₗ(l=1,2, . . . ,N) (5)

Equation (5) applies the Einstein convention. When a subscript appears twice in one term, the sum of the subscripts is calculated. The character q^{l} represents the generalized coordinate, the character Fₗ represents the generalized force (known quantity) corresponding to the generalized coordinate, and the character (M_{l,m}) represents the mass matrix corresponding to the vector q=(q^{l}) of collections of the generalized coordinate. Each of characters l, m, n represents the number of generalized coordinates, and a character N represents the number of generalized coordinates (dimension of the dynamical system). The character C_{l,m,n} is a Christoffel symbol of the first kind and is defined by following equation (6).

$$\begin{matrix}[ Math 6 ] & \\ {C}_{i , m , n} = \frac{1}{2} ( \frac{\partial {M}_{n , i}}{\partial {q}^{m}} + \frac{\partial {M}_{m , i}}{\partial {q}^{n}} - \frac{\partial {M}_{m , n}}{\partial {q}^{l}} ) & ( 6 )\end{matrix}$$

By substituting equation (6) into equation (5) and arranging it, following equation (7) is obtained. In this regard, following equation (8) is true.

$$\begin{matrix}[ Math 7 ] & \\ {\ddot{q}}^{l} = {M}^{l , m} \{ ( - {X}_{m , n} + \frac{1}{2} {X}_{n , m} ) {\dot{q}}^{n} + {ℱ}_{m} \} & ( 7 )\end{matrix}$$

$$\begin{matrix}[ Math 8 ] & \\ \begin{matrix}{M}_{l , m} {M}^{m , n} = {δ}_{l}^{n} \\ {X}_{l , m} = \frac{\partial {M}_{i , n}}{\partial {q}^{m}} {\dot{q}}^{n}\end{matrix} & ( 8 )\end{matrix}$$

Here, δⁿₗ is the Kronecker delta and is defined by following equation (9).

$$\begin{matrix}[ Math 9 ] & \\ {δ}_{l}^{n} = \{ \begin{matrix}1 & if l = n , \\ 0 & if l \neq n .\end{matrix} & ( 9 )\end{matrix}$$

The item (M^{l,m}) is the inverse of the mass matrix M_{GC}. According to equation (7), given the mass matrix and the partial differential of the mass matrix with respect to the generalized coordinates, it can be understood that the motion (generalized acceleration) caused by the acting force Fₗ can be calculated. In the forward dynamic analysis, the motion can be predicted by sequentially numerically integrating the obtained generalized acceleration. The degrees of freedom of the motion of the system are broadly divided into those derived from the degrees of freedom of the mechanism when the gaps in all of the pairs are zero, and those derived from the pair gaps. Therefore, it is considered that the generalized coordinates is set as expressed by following equation (10).

[symbol]

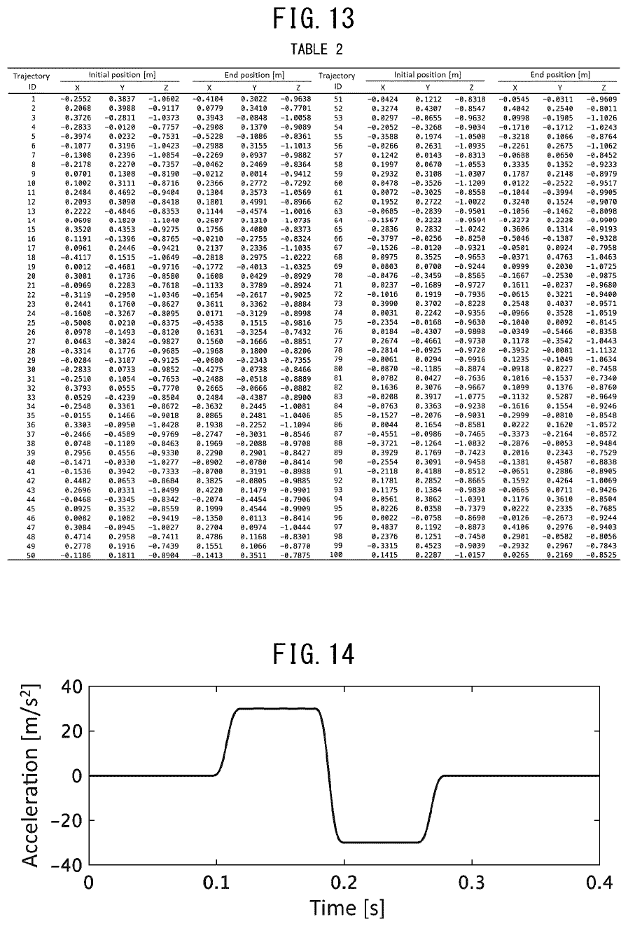

In equation (10), the character θᵢ represent the displacements of the three rotating pairs (actuators). The character J′ is the total number of the sphere pairs each having the gap to be considered, and the character S_{il′,jl′,kl′} is the l'-th sphere pair having the gap to be considered. As shown in FIG. 10, δ_{il′,jl′,kl′} represents a relative position vector between the centers of the pair elements (the ball 28 and the cup 30) considering the gap, and is referred to as a pair error vector. By setting the generalized coordinates in this way, it is possible to non-redundantly express the motion of the dynamic system. By solving the kinematics of the robot with respect to the set generalized coordinates, the coefficients M_{l,m} and C_{l,m,n} of the motion equation in equation (5) can be derived.

The mass matrix M_{GC} is expressed by following equation (11) using a matrix Mₗᵢₙₖ which collects the mass of the link and the inertia tensor of the barycentric coordinate system of the link.

[Math 11]

M_{GC}=^{t}A^{t}Jₐₗₗ(θ)⁻¹MₗᵢₙₖJₐₗₗ(θ)⁻¹A (11)

In this regard, Jₐₗₗ (=∂qₐₗₗ/∂qₗᵢₙₖ) the Jacobian matrix of the vector qₐₗₗ (θ, δₐₗₗ)) which collects the actuator displacement θ and the pair error δₐₗₗ of all passive pairs, relative to the center of gravity position and orientation (the local coordinates of the link) qₗᵢₙₖ of all links. Here, it is assumed that the pair error is sufficiently small compared to the mechanical constants such as the link length, and the Jacobian matrix Jₐₗₗ depends only on the actuator displacement θ. The character A is a matrix determined by the location where the gap is considered, and is defined by following equation (12).

$$\begin{matrix}[ Math 12 ] & \\ {}^{t} A = [ \begin{matrix}I & O & … & O & … & O & … & O & … & O \\ O & O & … & I & … & O & … & O & … & O \\ ⋮ & ⋮ & ⋱ & ⋮ & ⋱ & ⋮ & ⋱ & ⋮ & ⋱ & ⋮ \\ O & O & … & O & … & I & … & O & … & O \\ ⋮ & ⋮ & ⋱ & ⋮ & ⋱ & ⋮ & ⋱ & ⋮ & ⋱ & ⋮ \\ O & O & … & O & … & O & … & I & … & O\end{matrix} ] \begin{matrix} \\ ← 1 st \\ \\ ← l - th \\ \\ ← {J}^{′} - th\end{matrix} \\ \begin{matrix} & & & {↑}_{{s}_{1} - th} & & {↑}_{{s}_{i} - th} & {↑}_{{s}_{j ′} - th} & & \end{matrix} & ( 12 )\end{matrix}$$

The character I is the identity matrix, the character J′ represents the total number of pairs having gaps to be considered, and the character si represents the order number of the pair having the gap to be considered. The characters Mₗᵢₙₖ and A are matrices independent of the vector q. At this time, qₐₗₗ=Aq is true. By substituting equation (11) into equation (8), following equation (13) is obtained. In this regard, equation (14) is true, wherein the character t represents the transpose of the matrix.

$$\begin{matrix}[ Math 13 ] & \\ ( {X}_{l , m} ) = [ \frac{\partial {M}_{GC}}{\partial {q}^{1}} \dot{q} \cdot \frac{\partial {M}_{GC}}{\partial {q}^{2}} \dot{q} , … , \frac{\partial {M}_{GC}}{\partial {q}^{N}} \dot{q} ] & ( 13 )\end{matrix}$$

$$\begin{matrix}[ Math 14 ] & \\ \frac{\partial {M}_{GC}}{\partial {q}^{l}} \dot{q} = {}^{l} {A}^{t} {{J}_{all} ( θ )}^{- 3} ( M \text{?} {{J}_{all} ( θ )}^{- 1} \frac{\partial {J}_{all} ( θ )}{\partial {q}^{l}} + \frac{{\partial }^{t} {J}_{all} ( θ )}{\partial {q}^{l}} \text{?} {{J}_{all} ( θ )}^{- 1} {M}_{link} ) {{J}_{all} ( θ )}^{- 1} A \dot{q} & ( 14 )\end{matrix}$$

$$\text{?} \text{indicates text missing or illegible when filed}$$

Next, an equation for deriving Jₐₗₗ(θ) and ∂Jₐₗₗ(θ)/∂θ in the parallel link robot is determined. As shown in FIG. 9, a local Cartesian coordinate system is set for links Aᵢ, B_{i,j}, and the symbols in the figure are used as its basis vectors. The position of the pair and the position of the gravity center of the link are defined by the symbols in the figure. It is assumed that the mechanism constant is sufficiently large relative to the size of the gap, and all of the symbols in FIG. 9 use a result of displacement analysis when all of the size of the gaps is zero. Therefore, all of the symbols in FIG. 9 depend only on the displacement θ. The motion of link Aᵢ considers only one degree of freedom of rotation about axis e_{A,i,y} of the rotating pair Rᵢ, and the motion of link B_{i,j} considers three translational degrees of freedom of the center of gravity and two degrees of freedom of rotation, except for an extra degree of freedom (the rotation about e_{B,i,j,z}). Therefore, the mass matrix Mₗᵢₙₖ is composed of the above motion mass and inertia tensors. When the mechanism is not in the singular posture, the Jacobian matrix Jₐₗₗ(θ) becomes regular and is expressed by following equation (15) using the symbols in the figure.

$$\begin{matrix}[ Math 15 ] & \\ {J}_{all} ( θ ) = [ \begin{matrix}{I}_{3} & {O}_{3 , 5} & {O}_{3 , 5} & {O}_{3 , 5} & {O}_{3 , 5} & {O}_{3 , 5} & {O}_{3 , 5} & {O}_{3 , 6} \\ - {J}_{A , 1 , 1 , 1} & {J}_{B , 1 , 1 , 1} & {O}_{3 , 5} & {O}_{3 , 5} & {O}_{3 , 5} & {O}_{3 , 5} & {O}_{3 , 5} & {O}_{3 , 6} \\ - {J}_{A , 1 , 2 , 1} & {O}_{3 , 5} & {J}_{B , 1 , 2 , 1} & {O}_{3 , 5} & {O}_{3 , 5} & {O}_{3 , 5} & {O}_{3 , 5} & {O}_{3 , 6} \\ - {J}_{A , 2 , 1 , 1} & {O}_{3 , 5} & {O}_{3 , 5} & {J}_{B , 2 , 1 , 1} & {O}_{3 , 5} & {O}_{3 , 5} & {O}_{3 , 5} & {O}_{3 , 6} \\ - {J}_{A , 2 , 2 , 1} & {O}_{3 , 5} & {O}_{3 , 5} & {O}_{3 , 5} & {J}_{B , 2 , 2 , 1} & {O}_{3 , 5} & {O}_{3 , 5} & {O}_{3 , 6} \\ - {J}_{A , 3 , 1 , 1} & {O}_{3 , 5} & {O}_{3 , 5} & {O}_{3 , 5} & {O}_{3 , 5} & {J}_{B , 3 , 1 , 1} & {O}_{3 , 5} & {O}_{3 , 6} \\ - {J}_{A , 3 , 2 , 1} & {O}_{3 , 5} & {O}_{3 , 5} & {O}_{3 , 5} & {O}_{3 , 5} & {O}_{3 , 5} & {J}_{B , 3 , 2 , 1} & {O}_{3 , 6} \\ {O}_{3 , 3} & {J}_{B , 1 , 1 , 2} & {O}_{3 , 5} & {O}_{3 , 5} & {O}_{3 , 5} & {O}_{3 , 5} & {O}_{3 , 5} & - {J}_{C , 1 , 1 , 2} \\ {O}_{3 , 3} & {O}_{3 , 5} & {J}_{B , 1 , 2 , 2} & {O}_{3 , 5} & {O}_{3 , 5} & {O}_{3 , 5} & {O}_{3 , 5} & - {J}_{C , 1 , 2 , 2} \\ {O}_{3 , 3} & {O}_{3 , 5} & {O}_{3 , 5} & {J}_{B , 2 , 1 , 2} & {O}_{3 , 5} & {O}_{3 , 5} & {O}_{3 , 5} & - {J}_{C , 2 , 1 , 2} \\ {O}_{3 , 3} & {O}_{3 , 5} & {O}_{3 , 5} & {O}_{3 , 5} & {J}_{B , 2 , 2 , 2} & {O}_{3 , 5} & {O}_{3 , 5} & - {J}_{C , 2 , 2 , 2} \\ {O}_{3 , 3} & {O}_{3 , 5} & {O}_{3 , 5} & {O}_{3 , 5} & {O}_{3 , 5} & {J}_{B , 3 , 1 , 2} & {O}_{3 , 5} & - {J}_{C , 3 , 1 , 2} \\ {O}_{3 , 3} & {O}_{3 , 5} & {O}_{3 , 5} & {O}_{3 , 5} & {O}_{3 , 5} & {O}_{3 , 5} & {J}_{B , 3 , 2 , 2} & - {J}_{C , 3 , 2 , 2}\end{matrix} ] & ( 15 )\end{matrix}$$

In this regard, following equations (16) to (18) are true.

$$\begin{matrix}[ Math 16 ] & \\ {J}_{A , i , j , 1} = {[ \begin{matrix}{O}_{3 , 1} , & {[ \vec{{P}_{i} {Q}_{i , j , 1}} ]}_{x} & {e}_{A , i , y} , & {O}_{3 , 1} ]\end{matrix}}_{{↑}_{i - th column}} & ( 16 )\end{matrix}$$

$$\begin{matrix}[ Math 17 ] & \\ {J}_{B , l , j , k} = [ \begin{matrix}{I}_{3} , & {[ \vec{{O}_{B , i , j} {Q}_{i , j , k}} ]}_{x} & [ {e}_{B , i , j , x} , {e}_{B , i , j , y} ]\end{matrix} ] & ( 17 )\end{matrix}$$

$$\begin{matrix}[ Math 18 ] & \\ {J}_{C , i , j , 2} = [ \begin{matrix}{I}_{3} , & {[ \vec{{O}_{C} {Q}_{i , j , 2}} ]}_{x} ]\end{matrix} & ( 18 )\end{matrix}$$

In equations (15) to (18), the character In represents an n-th order identity matrix, the character O_{m,n} represents a matrix having m-row and n-column, and the character [*]ₓ represents a skew-symmetric matrix generated by the vector *. The partial differential ∂Jₐₗₗ(θ)/∂θᵢ′ of the Jacobian matrix is calculated by following equation (19) by partially differentiating equations (15) to (18). In this regard, equations (20) and (21) are true.

$$\begin{matrix}[ Math 19 ] & \\ \frac{\partial {J}_{all} ( θ )}{\partial θ \text{?}} = [ \begin{matrix}{O}_{3 , 3} & {O}_{3 , 5} & {O}_{3 , 5} & {O}_{3 , 5} & {O}_{3 , 5} & {O}_{3 , 5} & {O}_{3 , 5} & {O}_{3 , 6} \\ - \partial \text{?} {J}_{A , 1 , 1 , 1} & \partial \text{?} {J}_{B , 1 , 1 , 1} & {O}_{3 , 5} & {O}_{3 , 5} & {O}_{3 , 5} & {O}_{3 , 5} & {O}_{3 , 5} & {O}_{3 , 6} \\ - \partial \text{?} {J}_{A , 1 , 2 , 1} & {O}_{3 , 5} & \partial \text{?} {J}_{B , 1 , 2 , 1} & {O}_{3 , 5} & {O}_{3 , 5} & {O}_{3 , 5} & {O}_{3 , 5} & {O}_{3 , 6} \\ - \partial \text{?} {J}_{A , 2 , 1 , 1} & {O}_{3 , 5} & {O}_{3 , 5} & \partial \text{?} {J}_{B , 2 , 1 , 1} & {O}_{3 , 5} & {O}_{3 , 5} & {O}_{3 , 5} & {O}_{3 , 6} \\ - \partial \text{?} {J}_{A , 2 , 2 , 1} & {O}_{3 , 5} & {O}_{3 , 5} & {O}_{3 , 5} & \partial \text{?} {J}_{B , 2 , 2 , 1} & {O}_{3 , 5} & {O}_{3 , 5} & {O}_{3 , 6} \\ - \partial \text{?} {J}_{A , 3 , 1 , 1} & {O}_{3 , 5} & {O}_{3 , 5} & {O}_{3 , 5} & {O}_{3 , 5} & \partial \text{?} {J}_{B , 3 , 1 , 1} & {O}_{3 , 5} & {O}_{3 , 6} \\ - \partial \text{?} {J}_{A , 3 , 2 , 1} & {O}_{3 , 5} & {O}_{3 , 5} & {O}_{3 , 5} & {O}_{3 , 5} & {O}_{3 , 5} & \partial \text{?} {J}_{B , 3 , 2 , 1} & {O}_{3 , 6} \\ {O}_{3 , 3} & \partial \text{?} {J}_{B , 1 , 1 , 2} & {O}_{3 , 5} & {O}_{3 , 5} & {O}_{3 , 5} & {O}_{3 , 5} & {O}_{3 , 5} & {O}_{3 , 6} \\ {O}_{3 , 3} & {O}_{3 , 5} & \partial \text{?} {J}_{B , 1 , 2 , 2} & {O}_{3 , 5} & {O}_{3 , 5} & {O}_{3 , 5} & {O}_{3 , 5} & {O}_{3 , 6} \\ {O}_{3 , 3} & {O}_{3 , 5} & {O}_{3 , 5} & \partial \text{?} {J}_{B , 2 , 1 , 2} & {O}_{3 , 5} & {O}_{3 , 5} & {O}_{3 , 5} & {O}_{3 , 6} \\ {O}_{3 , 3} & {O}_{3 , 5} & {O}_{3 , 5} & {O}_{3 , 5} & \partial \text{?} {J}_{B , 2 , 2 , 2} & {O}_{3 , 5} & {O}_{3 , 5} & {O}_{3 , 6} \\ {O}_{3 , 3} & {O}_{3 , 5} & {O}_{3 , 5} & {O}_{3 , 5} & {O}_{3 , 5} & \partial \text{?} {J}_{B , 3 , 1 , 2} & {O}_{3 , 5} & {O}_{3 , 6} \\ {O}_{3 , 3} & {O}_{3 , 5} & {O}_{3 , 5} & {O}_{3 , 5} & {O}_{3 , 5} & {O}_{3 , 5} & \partial \text{?} {J}_{B , 3 , 2 , 2} & {O}_{3 , 6}\end{matrix} ] & ( 19 )\end{matrix}$$

$$\begin{matrix}[ Math 20 ] & \\ \partial \text{?} {J}_{A , i , j , 1} = {[ \begin{matrix}{O}_{3 , 1} , & {[ \frac{\vec{{P}_{i} {Q}_{i , j , 1}}}{\partial θ \text{?}} ]}_{x} & {e}_{A , i , y} , & {O}_{3 , 1}\end{matrix} ]}_{{↑}_{i - th column}} & ( 20 )\end{matrix}$$

$$\begin{matrix}[ Math 21 ] & \\ \partial \text{?} {J}_{B , i , j , k} = [ \begin{matrix}{O}_{3} , & {[ \frac{\vec{\partial {O}_{B , i , j} {Q}_{i , j , k}}}{\partial θ \text{?}} ]}_{x} & [ {e}_{B , i , j , x} , {e}_{B , i , j , y} ]\end{matrix} ] - [ \begin{matrix}{O}_{3} , & {[ \vec{{O}_{B , i , j} {Q}_{i , j , k}} ]}_{x} & [ \frac{\partial {e}_{B , i , j , x}}{\partial θ \text{?}} , \frac{\partial {e}_{B , i , j , y}}{\partial θ \text{?}} ]\end{matrix} ] & ( 21 )\end{matrix}$$

$$\text{?} \text{indicates text missing or illegible when filed}$$

In view of the above, when the derivation equation of the external force Fₗ is determined, the motion equation of motion can be formulated, and the forward dynamic analysis can be executed. The external force Fₗ is given by following equation (22) in consideration of a contact force Fⱼₒᵢₙₜ of the pair element, a drive torque F_{actuator} based on the control law of the actuator, and a gravitational force F_{gravity} acting on each link.

[Math 22]

(Fₗ)=Fⱼₒᵢₙₜ+F_{actuator}+F_{gravity} (22)

In the present disclosure, Lankarani's model, which considers energy loss in Hertz's elastic contact theory, is used as a contact model for expressing the separation, collision, and sliding of the pair elements. It is desirable to use a contact model of the pair elements which is suitable for the state and material of the pair. The calculated torque method, which is frequently used in industrial robots, is used as the actuator control law.

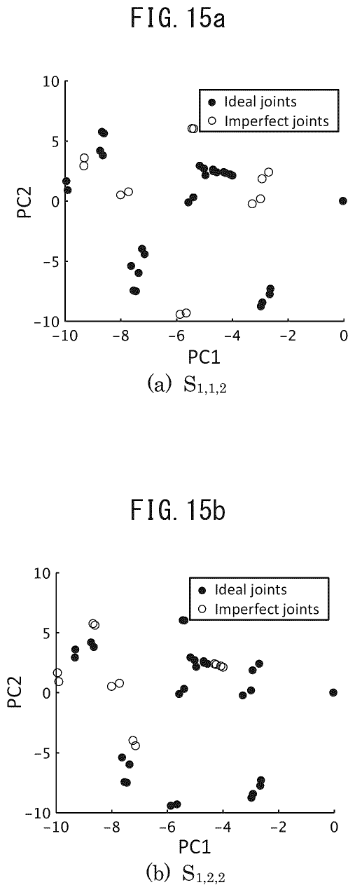

FIG. 11 is a block diagram showing an example of the calculated torque method. The characters Kp and Kd represent P and D gains of the calculated torque method, respectively, the character s represents a differential operator, the character M (θ) represents the mass matrix, the character V (θ, sθ) represents a generalized force corresponding to a combination of the gravity force and a gyro moment. In order to derive M (θ) and V (θ, sθ), the model of the mechanism in which all spherical pairs are ideal is used. The driving torque τ generated in the actuator can be calculated by the process as shown in FIG. 11. From the above, Fₗ, M_{l,m} and C_{l,m,n} can be calculated, and thus the motion equation can be solved.

### (Experimental Verification)

In order to verify the validity of the identification of the pair gap according to the present disclosure, a drive torque measurement experiment was conducted using an actual robot. Here, actual machine measurement and dynamic analysis were previously performed under a condition in a plurality of pair gaps and trajectories, respectively, and the obtained data were used in combination.

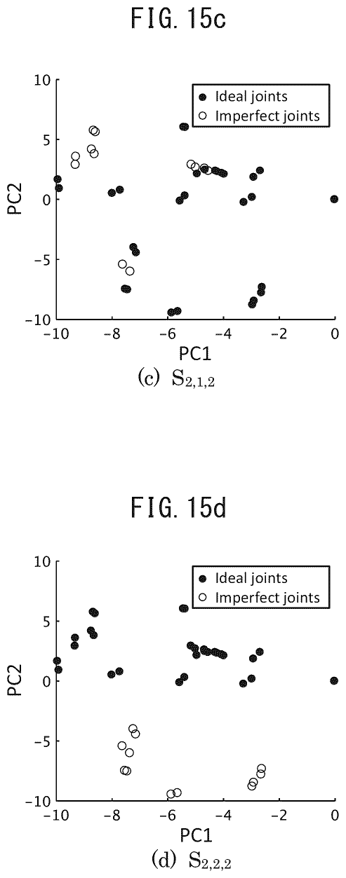

FIG. 12 (Table 1) shows combinations of pair gaps for which the dynamic analysis and the actual machine measurement were performed. The magnitudes of the radial gaps in the used pairs used were 0.00 mm, 0.14 mm and 0.15 mm (actual measurement values). In the table, the characters 0, A and B indicate the radial gaps of 0.00 mm, 0.14 mm and 0.15 mm, respectively. In Table 1, three conditions in which the number of sphere pairs with excessive gaps (0.14 mm, 0.15 mm) is zero (case 1), one (case 2-13), and two (case 14-43), respectively, were set. Also, in order to limit the scale of the experiment, among the twelve sphere pairs, only the excessive gaps in the six sphere pairs located at the output node (corresponding to the ball joints 26a to 26c in FIG. 1) were considered.

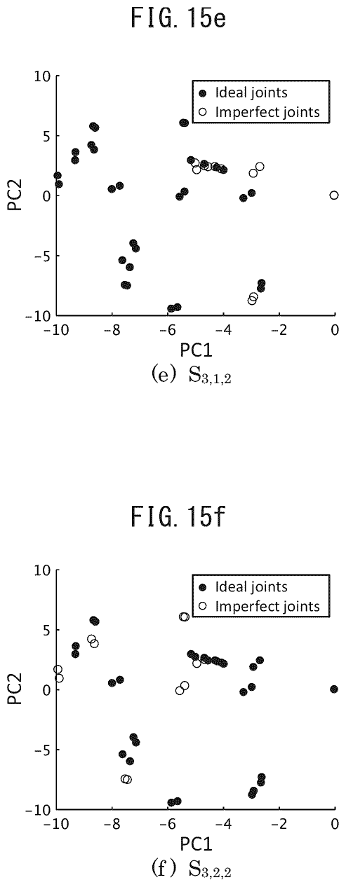

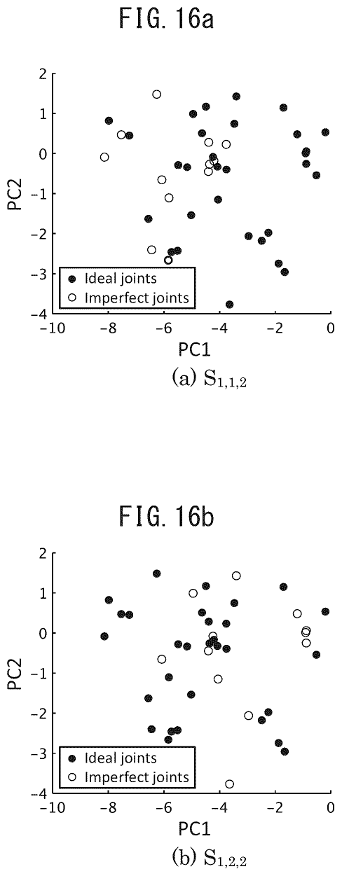

In Table 1, for the sphere pair indicated as 0, the actual machine measurement was performed using an ideal sphere pair with a measured gap of 0.00 mm, and the numerical calculation was performed under the ideal sphere pair in the dynamic analysis. For the sphere pair indicated as 0.14 mm and 0.15 mm, the numerical calculation was performed using these values in the dynamic analysis. The trajectory used for the measurement and analysis was a straight trajectory along which the output node is moved by a constant distance l₀ (in this case, l₀=200 mm). A large number (in this study, one hundred) of linear trajectories were generated by randomly selecting start and end points of the trajectories from a working area. FIG. 13 (Table 2) collectively shows the coordinates of the start and end points of the plurality of actually generated trajectories. In all of the trajectories, the same deformed trapezoidal curve was used as the acceleration waveform in the direction of motion of the output node. FIG. 14 shows the acceleration waveform in the motion direction of the output node.

In this way, the waveform data of the drive torque in the actual machine measurement and dynamic analysis were acquired under various conditions with respect to the pair gap and the trajectory. Hereinafter, the condition of the pair gap is discriminated by using the subscript n′, and the trajectory is discriminated by using the subscript m′. The present disclosure was verified by repeatedly identifying the pair gaps by combining the acquired data.

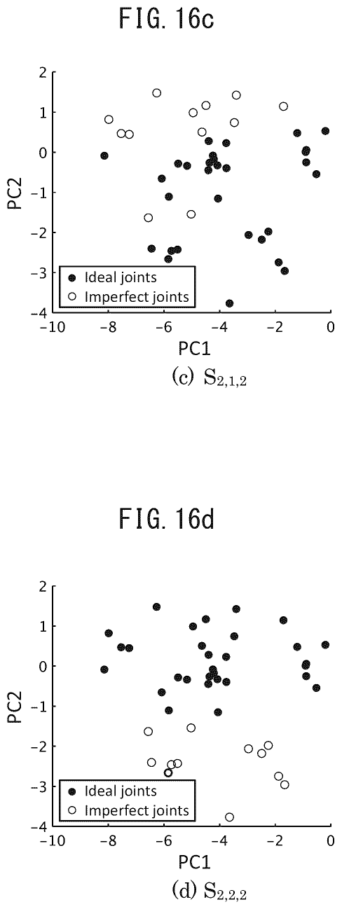

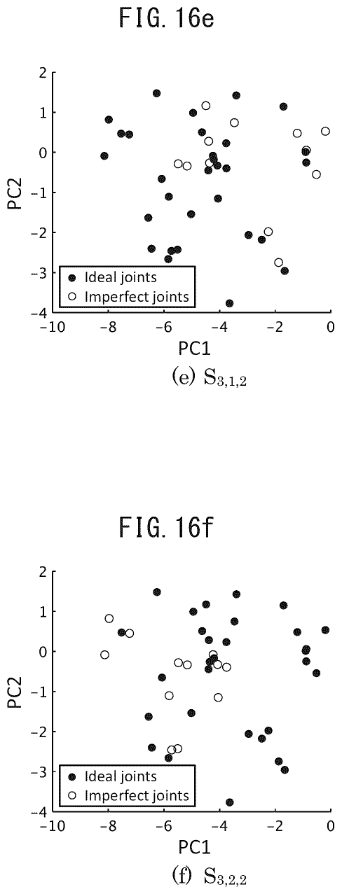

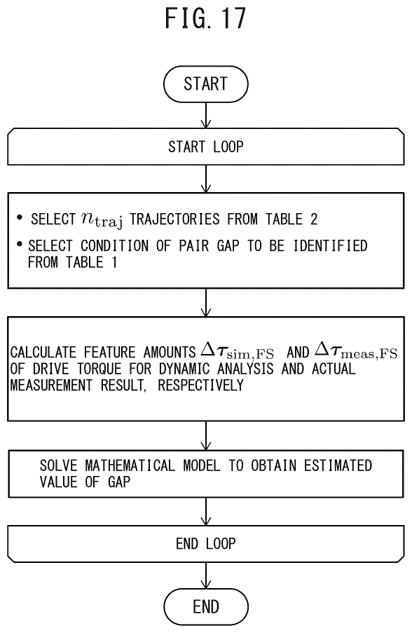

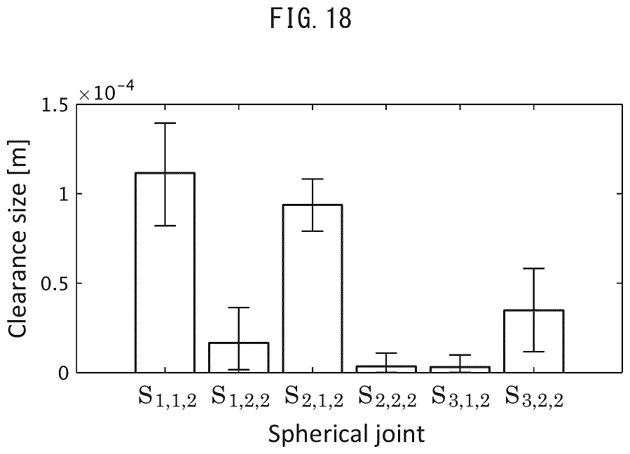

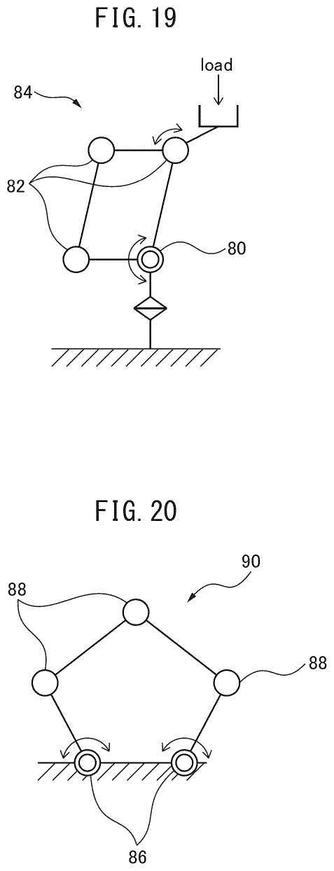

The result of feature selection when using the trajectory 1 (m′=1) in Table 2 is explained. First, the waveforms Δτ_{sim,1,n′}(t) and ΔΣ_{meas,1}(t) of the difference in the drive torque in each actuator relative to the waveforms when the gaps in all sphere pairs are sufficiently small were calculated. Since the dynamic analysis results were obtained by executing the dynamic analysis under many gap conditions, principal component analysis was executed on these results Δτ_{sim,1,n′}(t). FIGS. 15a to 15f show scatter plots for the first principal component score (PC1) and the second principal component score (PC2). FIGS. 15a to 15f are scatter plots of the same data, but ideal sphere pairs are represented by black circle markers, whereas sphere pairs with excessive gaps are represented by white circle markers.

Next, similar graphs were created for the actual machine measurement results. The magnitude of the orthogonal projection of the actual machine measurement results (the collection of the waveforms of difference for all actuators) onto each principal component vector obtained by the principal component analysis of the dynamic analysis results was the principal component score of the actual machine measurement result data. FIGS. 16a to 16f show scatter diagrams of the first principal component score (PC1) and the second principal component score (PC2) of the actual machine measurement results under all pair gap conditions where the measurements were carried out. According to FIGS. 15a to 16f, although the scale of the vertical axis (PC2) differs between the dynamic analysis results and the actual machine measurement results, the pattern of the black circles and the pattern of the white circles are similar; in particular, it can be seen that the effect of the gap of the sphere pair S_{2,2,2} appears particularly on the second principal component score (FIG. 16d). Since the effect of the pair gap by the principal component analysis can be extracted in this way, it is possible, by combining various trajectory data, to identify the pair gap with high accuracy by constructing and solving the mathematical model using the principal component score.

Next, the validity of the present disclosure was verified by identifying the pair gap and comparing the obtained estimated value of the gap to the actual size of the gap. FIG. 17 is a flowchart showing an example of the verification procedure. In this verification, the pair gap was repeatedly identified while randomly changing the combination of data to be used.

First, a set of trajectories to be used for identifying the gap was determined. Here, nₜᵣₐⱼ trajectories were randomly selected from one hundred trajectories. As for the data for the dynamic analysis, all (forty-three) combinations of data shown in Table 1 were selected for the analysis results of the nₜᵣₐⱼ trajectories. As for the actual machine measurement results, one combination was randomly selected from the (forty-three) combinations shown in Table 1 as the data of the pair gap condition for identification. The obtained data set was subjected to the gap identification process shown in FIG. 4 so as to obtain an estimated value of the magnitude of the gap for each sphere pair. Since the magnitude of the gap in the sphere pair used in the actual machine measurement was previously measured, it was possible to obtain a set of the estimated value and the actual measurement value of the gap in the sphere pair. By repeating this process, it was possible to obtain the set of actual measurement value and the estimated value of the magnitude of the pair gap, and to evaluate the estimation performance. In this verification, the loop shown in FIG. 17 in which nₜᵣₐⱼ=10 was repeated one hundred times so as to identify the pair gap.

Next, the result of one execution result among one hundred execution results of identifying the pair gap will be described. The numbers of selected trajectories (the numbers shown in Table 2) were (64, 60, 58, 80, 70, 55, 67, 44, 35, 61), and the number indicating the gap condition to be identified (the number shown in Table 1) was 15. The measured gaps were 0.14 mm for S_{1,1,2}, 0.15 mm for S_{2,1,2}, and 0 mm for the other sphere pairs. FIG. 18 shows estimated values of the pair gaps at this time. In this figure, a 95% confidence interval of Bayesian estimation is represented by an error bar. From the figure, although there were variations in the estimated values of the gap, a large value was estimated for the sphere pair having an actually excessive gap, and thus the usefulness of the present disclosure has been confirmed.

In the embodiment as explained above, although the determination is made using the drive torque of the motor as the output value thereof, the time differential value of the drive torque may be used instead. Also, instead of using the value relating to the drive torque (here, the drive torque or its time differential value), a value relating to its current value (e.g., a current value or its time differential value) may be used as the output value of the motor. Since the drive torque is usually proportional to the current value, the same process as described above can be applied even when the value relating to the current value is used. Furthermore, in the above embodiment, the first gap amount is identified using the feature amount representing the variation in the output value of the motor, but the variation data itself can be used instead of the feature amount.

In the embodiment, although the parallel link robot is explained as a robot to which the gap detection device and the gap detection method of the present disclosure can be applied, the object to which the device and the method can be applied is not limited as such. As another preferable example to which the gap detection device and the gap detection method of the present disclosure can be applied, a six-axis multi-joint robot which does not have a closed-loop link mechanism, or a robot at least partially having a closed-loop link mechanism as schematically shown in FIG. 19 or 20, may be used.

FIG. 19 shows a robot 84 having a planar link mechanism including one drive joint 80 and three passive joints 82, in which a load can be applied to a front end of the robot. On the other hand, FIG. 20 shows a robot 90 configured to be used as a positioning device, etc., having a five-jointed link mechanism including two drive joints 86 and three passive joints 88. These robots have, similarly to the parallel link robot as shown in FIG. 1, the drive link driven by the motor, the plurality of passive links driven by the motion of the drive link, and the plurality of pairs respectively connected to the passive links. Therefore, also in these robots, the joint (or the passive pair) having the abnormal gap can be detected or identified, as described above.

In the embodiment, although the sphere joint (or the ball joint) is explained as a pair (or a joint) to which the gap detection device and the gap detection method of the present disclosure can be applied, the object to which the device and the method can be applied is not limited as such. For example, the gap detection device and the gap detection method can be applied to a hinge structure (or a rotational joint) having one degree-of-freedom. In such a case, the rotating joint (or the hinge structure) has, as the pairing elements, a generally columnar member (or a convex portion) and a generally cylindrical member (or a concave portion) configured to fit with the columnar member. Also in such a hinge structure, an abnormal gap may occur between the columnar member and the cylindrical member in the radial direction thereof, due to temporal deterioration (e.g., frictional wear of at least one of the columnar member, the cylindrical member, and a liner between the members), etc., of the hinge structure. Therefore, the gap detection device and the gap detection method of the present disclosure can also be applied to the hinge structure, etc.

In the present disclosure, a program for causing the gap detection device to execute the above process can be stored in the storage unit of the device or another storage device. The program can also be provided as a non-transitory computer-readable recording medium (a CD-ROM, a USB memory, etc.) on which the program is recorded.

### REFERENCE SIGNS LIST

10 parallel link robot
12 base part
14 movable part
16a link part
18a motor
20a drive link
22a passive link
24a, 26a ball joint (sphere bearing)
28 ball
30 housing
32 liner
34a restraining plate
36 controller
38 gap detection device
40 simulation unit
42 gap calculation unit
44 measurement unit
46 feature amount calculation unit
48 judgment unit
50 storage unit
52 output unit
53 input unit
80, 86 drive joint
82, 88 passive joint
84 parallel link type robot
90 five-jointed link type robot

1. A gap detection device for a robot, the robot comprising:
a drive link configured to be driven by a motor;
a plurality of passive links configured to be driven by a motion of the drive link; and
a plurality of pairs respectively connected to the plurality of passive links,
wherein the gap detection device is configured to detect a first gap amount between pairing elements of a pair connected to the passive link, and the gap detection device comprises:
a measurement unit configured to measure a drive torque or a current value of the motor when the robot is actually moved along an arbitrary motion trajectory;
a simulation unit configured to set an arbitrary second gap amount between pairing elements of the plurality of pairs, execute a simulation in which the robot is moved along the same motion trajectory as the arbitrary motion trajectory, and estimate the drive torque or the current value of the motor;
a feature amount calculation unit configured to calculate a first feature amount representing a variation in a value relating to the drive torque or the current value measured by the measurement unit and a second feature amount representing a variation in a value relating to the drive torque or the current value estimated by the simulation unit; and
a gap calculation unit configured to calculate an index relating to the first gap amount based on the first feature amount, the second feature amount and the second gap amount.

2. The gap detection device according to claim 1, wherein the gap calculation unit generates a mathematical model which associates the first feature amount, the second feature amount, the first gap amount and the second gap amount, and calculates the index relating to the first gap amount based on the mathematical model.

3. The gap detection device according to claim 2, wherein the mathematical model is a probability model.

4. The gap detection device according to claim 3, wherein the gap calculation unit calculates the index relating to the first gap amount based on a probability distribution relating to the probability model.

5. The gap detection device according to claim 1, wherein the feature amount calculation unit calculates the first feature amount and the second feature amount by principal component analysis.

6. The gap detection device according to claim 1, wherein the gap calculation unit divides a period of time before and after a time point when the motion trajectory changes, the measurement unit measures the drive torque or the current value using the same motion trajectory in each of the divided periods of time, and the gap calculation unit identifies an amount of change in the gap in all of the divided periods of time, and calculates the index relating to the first gap amount by adding these amounts of change.

7. The gap detection device according to claim 1, further comprising a judgment unit configured to judge as abnormal the gap of the pair whose index relating to the first gap amount exceeds a predetermined reference value, among the plurality of pairs.

8. The gap detection device according to claim 1, wherein the drive link and the passive links constitute at least one closed-loop link.

9. A gap detection method for a robot, the robot comprising:
a drive link configured to be driven by a motor;
a plurality of passive links configured to be driven by a motion of the drive link; and
a plurality of pairs respectively connected to the plurality of passive links,
wherein the gap detection method is to detect a first gap amount between pairing elements of a pair connected to the passive link, and the gap detection method comprises the steps of:
measuring a drive torque or a current value of the motor when the robot is actually moved along an arbitrary motion trajectory;
setting an arbitrary second gap amount between pairing elements of the plurality of pairs, executing a simulation in which the robot is moved along the same motion trajectory as the arbitrary motion trajectory, and estimating the drive torque or the current value of the motor;
calculating a first feature amount representing a variation in a value relating to the measured drive torque or the measured current value and a second feature amount representing a variation in a value relating to the estimated drive torque or the estimated current value; and
calculating an index relating to the first gap amount based on the first feature amount, the second feature amount and the second gap amount.

10. A gap detection device for a robot, the robot comprising:
a first link configured to be driven by a motor;
a second link configured to the first link; and
one or more pair connected to the second link,
wherein the gap detection device is configured to detect a first gap amount between pairing elements of a pair connected to the second link, and the gap detection device comprises:
a measurement unit configured to measure a first output value of the motor when the robot is actually moved along an arbitrary motion trajectory;
a simulation unit configured to set an arbitrary second gap amount between pairing elements of the pair, execute a simulation in which the robot is moved along the motion trajectory, and estimate a second output value of the motor; and
a gap calculation unit configured to calculate the first gap amount based on a change in the first output value, a change in the second output value and the second gap amount.
